(19) United States
(12) Patent Application Publication
(10) Pub. No.: US 2020/0106776 A1
(43) Pub. Date: Apr. 2, 2020

(54) AUTHENTICATION SERVER, AUTHENTICATION SYSTEM AND METHOD FOR AUTHENTICATION

(71) Applicant: Konica Minolta Laboratory U.S.A., Inc., San Mateo, CA (US)

(72) Inventor: Hiroyasu Ito, Foster City, CA (US)

(73) Assignee: Konica Minolta Laboratory U.S.A., Inc., San Mateo, CA (US)

(21) Appl. No.: 16/146,824

(22) Filed: Sep. 28, 2018

(51) Int. Cl. H04L 29/06; H04L 9/32; H04N 1/00

(52) U.S. Cl. CPC H04L 63/0884; H04L 63/083; H04N 2201/0094; H04N 1/00225; H04N 1/00244; H04L 9/321

(57) ABSTRACT

An authentication server includes a data storage that stores user data and a processor. The processor receives: first information including an authentication identification, a first device type and first use-case information that identifies at least one of external servers requested to be accessed from a first client device; and second information including an authentication identification, a second device type and second use-case information that identifies at least one of the external servers requested to be accessed from a second client device; performs an authentication by comparing the authentication identification with original authentication identification stored in the data storage; obtains first credential information corresponding to the first information and second credential information corresponding to the second information from the user data when the authentication succeeds; and transmits the first credential information to the first client device and the second credential information to the second client device.

### BACKGROUND

### Technical Field

The present invention generally relates to an authentication server, an authentication system, and a method for authentication.

### Description of Related Art

Storing digital information on storage servers on the internet has become common. With this trend, it has also become more important for users to rely on and manage credential information (e.g., ID (Identification) and passwords) for authentication purposes, to access such storage servers. However, from a practical standpoint, because credentials as text information are set differently for each use, for each group of common users, etc., a user must keep and manage different kinds of credentials corresponding to each of the services provided through a network like the internet. The added burden of managing various and multiple credentials also leads to increased risk for information leakage.

Some applications integrally manage the credentials. For example, certain browser applications store passwords, and a user of the browser applications can choose to access and use the services through the network without entering a password.

### SUMMARY

One or more embodiments of this disclosure provide a highly-secured authentication server, a highly-secured authentication system, and a highly-secured method for authentication.

One or more embodiments provides an authentication server including a data storage that stores user data and original authentication identification, and a processor. The processor receives: first information including an authentication identification, a first device type, and first use-case information that identifies one or more of external servers requested to be accessed from a first client device indicated by the first device type; and second information including the authentication identification, a second device type, and second use-case information that identifies one or more of the external servers requested to be accessed from a second client device indicated by the second device type; performs an authentication by comparing the authentication identification with the original authentication identification stored in the data storage; obtains, from the user data upon successful authentication, first credential information corresponding to the first information and second credential information corresponding to the second information from the user data when the authentication succeeds; and transmits the first credential information to the first client device and the second credential information to the second client device.

The credential information may include a plurality of credential sets, each composed of an ID and a password.

The first credential information and the second credential information may be stored in tables that are different for each device type.

The first client device may be a MFP (Multi-Function Peripheral) client; and information by using the first credential information to obtain a document to be printed out the MFP client may access the one or more of the external servers designated by the first use-case.

When the user data stores an access authority information to a management server corresponding to the authentication identification, the first credential information and the second credential information may both include credential information of the management server.

The processor may further obtain the credential information of the management sever from the management server.

The management server may store individual information of a plurality of users.

The first client device may be a MFP (Multi-Function Peripheral) client; the MFP client may access the management server by using the credential information of the management server to obtain an email address as the individual information; and the MFP client may scan a document and send the scanned document to the email address.

One or more embodiments provides an authentication system including: a first client device that transmits first information including an authentication identification, a first device type corresponding to the first client device and first use-case information that identifies one or more external servers requested to be accessed by the first client device; a second client device that transmits second information including an authentication identification, a second device type corresponding to the second client device, and first use-case information that identifies one or more the external servers requested to be accessed by the first client device; an authentication server comprising a data storage that stores user data and original authentication identification, wherein the authentication server that: receives the first information and the second information; performs an authentication by comparing the authentication identification with the original authentication identification stored in the data storage; and upon successful authentication, transmits first credential information corresponding to the first information to the first client device and second credential information corresponding to the second information to the second client device; and a communication network that connects the authentication server with the client device; wherein: the first client device uses the first credential information to access the one or more of the external servers designated by the first use-case information; and the second client device uses the second credential information to access the one or more of the external servers designated by the second use-case information.

One or more embodiments provides a method for an authentication comprising: storing user data; receiving: first information including an authentication identification, a first device type and first use-case information that identifies at least one of external servers requested to be accessed from a first client device indicated by the first device type; and second information including an authentication identification, a second device type and second use-case information that identifies at least one of the external servers requested to be accessed from a second client device indicated by the second device type; performing an authentication by comparing the authentication identification with original authentication identification stored in the data storage; obtaining first credential information corresponding to the first information and second credential information corresponding to the second information from the user data when the authentication succeeds; and transmitting the first credential information to the first client device and the second credential information to the second client device.

### BRIEF DESCRIPTION OF DRAWINGS

FIG. 1 shows a schematic view of the authentication system according to one or more embodiments.

FIG. 2 shows a hardware diagram of the authentication server according to one or more embodiments.

FIG. 3 shows a flow chart of an authentication process executed by the authentication system according to one or more embodiments.

FIG. 4 shows an operation diagram of the MFP client authenticating the user according to one or more embodiments.

FIG. 5 shows the contents of the first information transmitted from the client devices to the authentication server according to one or more embodiments.

FIG. 6 shows a flow chart of an authentication process executed by the authentication server according to one or more embodiments.

FIG. 7 shows an MFP table of the user data according to one or more embodiments.

FIG. 8 shows a decision table for the MFP client for deciding the credential sets to be transmitted, depending on the management server account according to one or more embodiments.

FIG. 9 shows an operation diagram of the mobile client authenticating the user according to one or more embodiments.

FIG. 10 shows a decision table for the mobile client or the computer client for deciding the credential sets to be transmitted, depending on the management server account according to one or more embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

[Configuration of Authentication System]

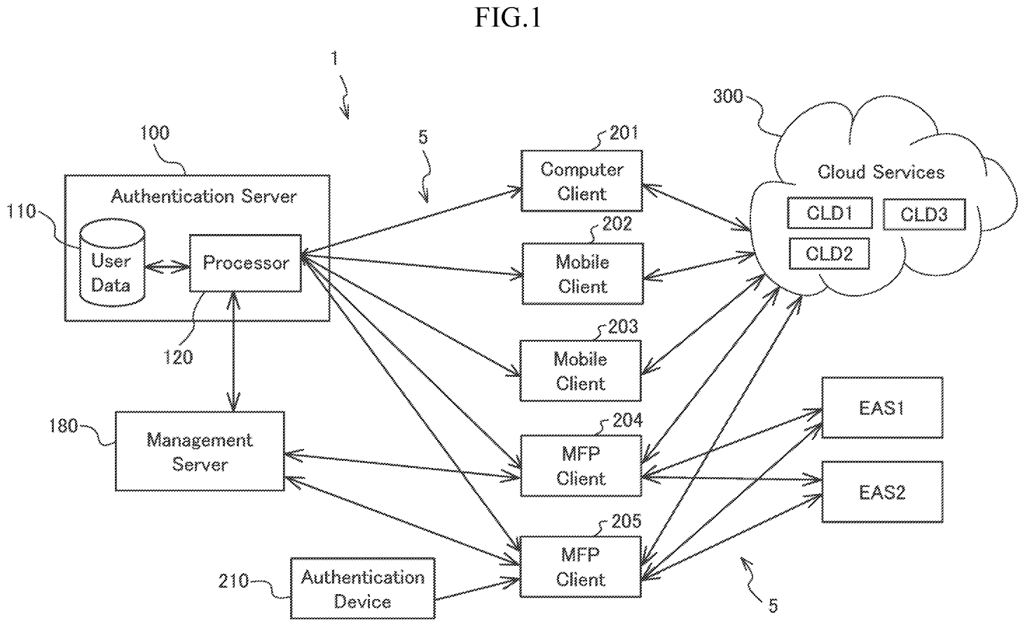

FIG. 1 shows a schematic view of an authentication system 1 according to one or more embodiments. As shown in FIG. 1, the authentication system 1 includes an authentication server 100, client devices 201-205, communication network 5, an authentication device 210, a management server 180, cloud services 300 including cloud servers CLD1, CLD2 and CLD3, and external application servers EAS1 and EAS2. The communication network 5 may be the internet.

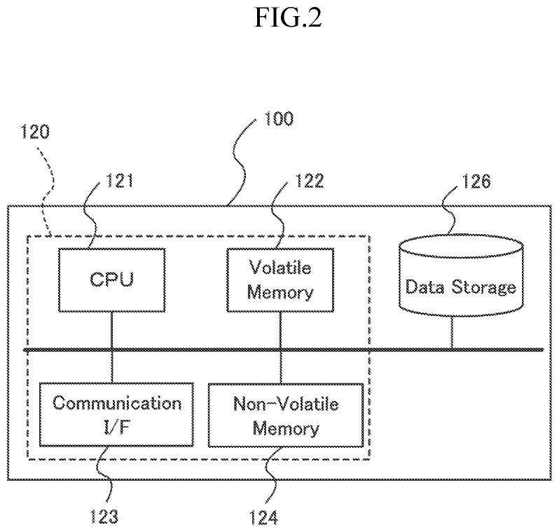

FIG. 2 shows a hardware diagram of the authentication server 100 according to one or more embodiments. As shown in FIG. 2, the authentication server 100 is an information processing device including a data storage 126, a CPU (central processing unit) 121, a volatile memory 122, a non-volatile memory 124 and a communication interface 123. The data storage 126 may be non-volatile memory such as hard disks or flash memories etc., and stores user data 110 which will be explained below. The volatile memory 122 can include RAM (random access memory) or cache memory, etc. The non-volatile memory 124 can include ROM (read only memory), flash memory or hard disk, etc. The communication interface 123 connects to the communication network 5 to communicate with other devices that also connect to the communication network 5. In the following description, the CPU 121, the volatile memory 122, non-volatile memory and communication interface 123 are collectively referenced as processor 120. However, it is also possible that the processor 120 includes only the CPU 121, or includes CPU 121 and any one or more of the volatile memory 122, non-volatile memory, communication interface 123, etc. The hardware configuration of the processor 120 as shown in FIG. 2 is also applicable to the management server 180, the client devices 201-205, the authentication device 210, the cloud servers CLD1-CLD3, and the external application servers EAS1-EAS2.

Referring back to FIG. 1, the processor 120 of the authentication server 100 connects to each of the client devices 201 to 205 through the network 5. The client devices 201-205 can be a computer client 201, a mobile client 202, a mobile client 203, a MFP (Multi-Function Peripheral) client 204, and an MFP client 205. The computer client 201 may be a desktop or laptop computer. The mobile client 202 may be a smart phone or the like that operates based on the execution of a mobile operating system referred as “Mobile OS1.” The mobile client 203 may similarly be a smart phone or the like that operates based on the execution of a mobile operating system referred as “Mobile OS2” that is different from Mobile OS1. The MFP clients 204-205 may be a printer for printing paper documents and may also include scanning documents function, facsimile function, etc. The “client devices” in the following description may include one or more client devices of the computer client 201, the mobile client 202, the mobile client 203, the MFP client 204, and the MFP client 205.

The external application servers EAS1-EAS2 may store electronic documents including multimedia files. The MFP clients 204-205 may connect with the external application servers EAS1 and/or EAS2 through the communication network 5, depending on credential information of the user. For example, if the user of the MFP client 204 has the credential information of one of the external application servers EAS1 and/or EAS2, then the MFP client 204 may download a document from the external application servers EAS1 and/or EAS2 and print the document out according to the operation by the user of the MFP client 204 (called “PullPrint”). Further, for example, the MFP client 204 may scan a document and upload the scanned document to the external application servers EAS1 and/or EAS2. The scanned documents can also be sent to the user's email address (called “ScanToMe”). One or both of the MFP clients 204-205 may access one or more external application servers, or one or both of the MFP clients 204-205 may be prevented from accessing any external application servers.

The cloud servers CLD1-CLD3 may store electronic documents including multimedia files. Based on the credential information of the user, the client devices 201-205 can access one or more cloud servers CLD1-CLD3.

The authentication device 210 may authenticate the user. The authentication device 210 may be a biometric authentication device, IC (Integrated Circuit) card, or some other authentication device. The authentication device 210 may include keypad for inputting ID and password. The authentication device 210 may be one of the client devices 201-205, for example the mobile client 202 or 203 having a fingerprint authentication function.

The user data 110 in the data storage 126 includes credential information. The credential information may be a credential set composed of an ID and a password, and may also include a plurality of credential sets. The credential information may also include credential information for accessing the cloud servers CLD1-CLD3 and the external application servers EAS1-EAS2. The management server 180 may also store the credential information. For example, the management server 180 may store the credential information for the client devices 201-205, such as the MFP clients 204-205. The management server may also store individual information of users. The individual information may include the email address of users.

[Process of Authentication System]

Described below are the processes executed by the authentication system 1 utilizing the MFP client 205 as the first client device and the mobile client 203 as the second client device, in accordance with one or more embodiments. However, any other client devices 201-205 could be utilized in the authentication system 1.

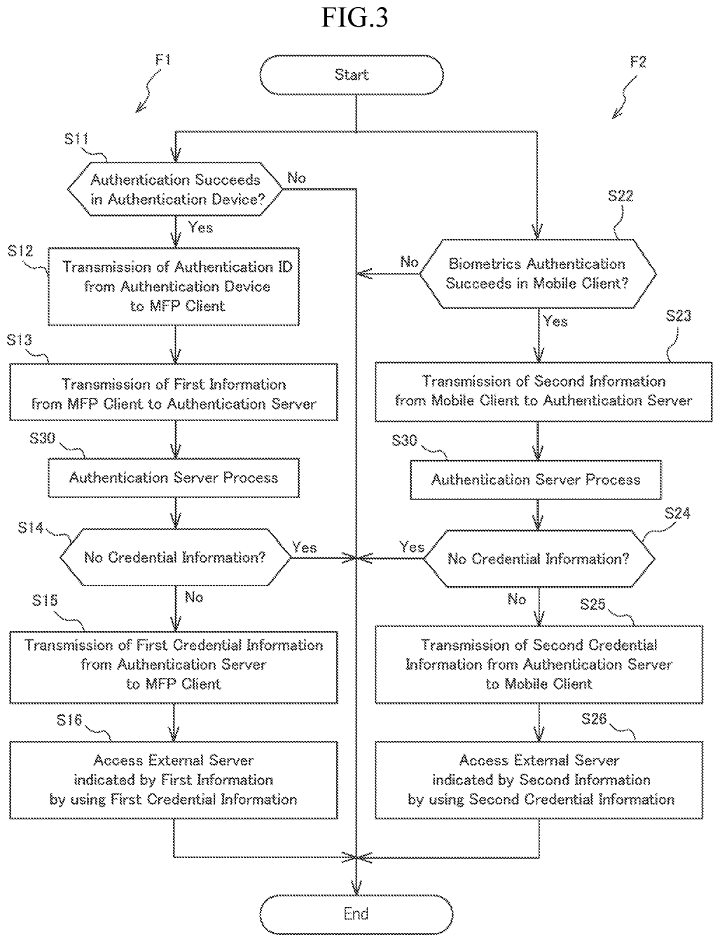

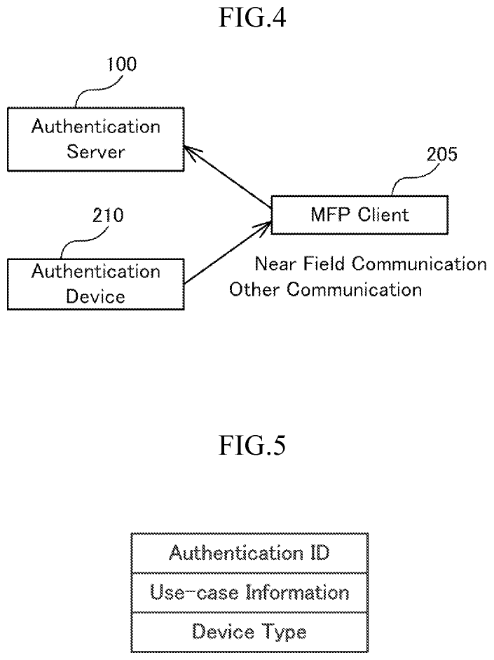

FIG. 3 shows a flow chart of the process executed by the authentication system according to one or more embodiments. As shown in FIG. 3, the flow chart includes two flows: flow F1 shown on the left and flow F2 shown on the right. Each of the flows F1 and F2 may proceed independently, utilizing the same authentication ID (identification). In the flow F1, firstly, the user operates the authentication device 210 to authenticate the user (step S11). If the authentication fails, the process of the authentication system ends. If the authentication succeeds, the authentication device 210 transmits the authentication ID corresponding to the user to the MFP client 205 (step S12). As shown in FIG. 4, the transmission between the authentication device 210 and the MFP client 205 can be performed by any of the contact-type communication and non-contact type communication. The contact-type communication includes, for example, serial communication like USB® (Universal Serial Bus). The non-contact type communication includes, for example, NFC (Near Field Communication) and other types of wireless communication.

Upon receiving the authentication ID, the MFP client 205 obtains first use-case information and a first device type that indicates the machine type of the MFP client 205. The first use-case information identifies at least one external server that the MFP client 205 is requesting to access. Examples of the first use-case information of the MFP client 205 are identifications of the external servers like the cloud servers CLD1-CLD3 or the external application servers EAS1-EAS2. Other examples of the first use-case information may indicate logging in to a web-based service application or logging in to the service application provided by a client device. The MFP client 205 may obtain the first use-case information based on the information from the input device, such as the touch panel of the MFP client 205. It is also possible for the MFP client 205 to decide the use-case information based only on the received authentication ID.

The authentication ID, the first use-case information, and the first device type may constitute a first information as shown in FIG. 5. The first information is transmitted from the MFP client 205 to the authentication server 100 (step S13). Upon receiving the first information, the authentication server 100 executes the authentication server process (step S30). However, the first use-case information and/or the first device type need not necessarily be included in the first information. This is because, for example, if the user has already been accessing one of the client devices 201-205, the device type need not be sent.

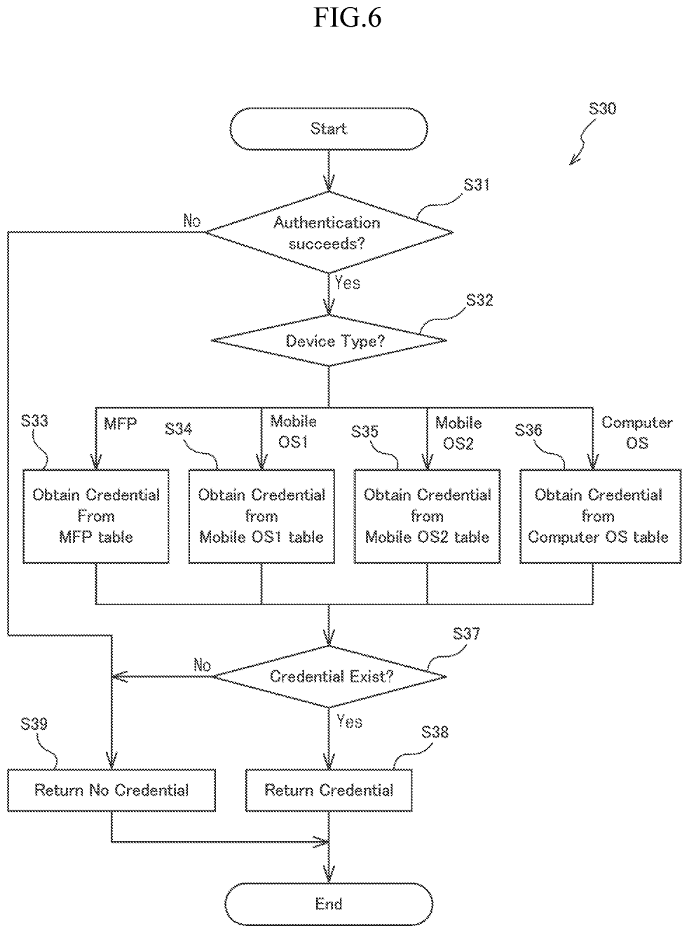

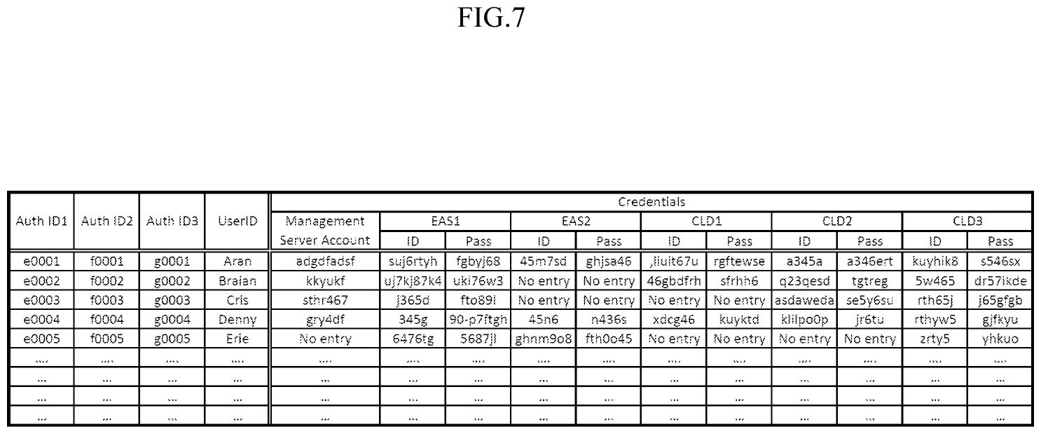

In the descriptions relating to FIGS. 6 and 7, for purposes of illustration, the “device type” refers to either the first device type or the second device type, the “use-case information” refers to either the first use-case information or the second use-case information, and the “credential information” refers to either the first credential information or the second credential information.

FIG. 6 shows a flow chart of the authentication server process (step S30). As described above, the authentication server 100 includes the data storage 110 and the processor 110. Upon receiving the first information, the processor 120 performs the authentication by using the authentication ID (step S31). The authentication may entail comparing the authentication ID with the original authentication identification (ID) stored in the data storage 126. If the authentication fails, the process proceeds to step S39 and returns no credential. If the authentication succeeds, the processor 120 confirms, for example, the first device type (step S32). If the first device type is an MFP, the processor 120 obtains the first credential information from the MFP table stored in the user data 110 (step S33). As another example, if the first device type is a mobile OS1, the processor 120 obtains the first credential information from the mobile OS1 table stored in the user data 110 (step S34). As another example, if the first device type is Mobile OS2, the processor 120 obtains the first credential information from the Mobile OS2 table stored in the user data 110 (step S35). As another example, if the first device type is computer OS, the processor 120 obtains the first credential information from the computer OS table stored in the user data 110 (step S36). The first credential information can be stored in tables that are different in each first device type.

FIG. 7 shows an MFP table stored in the user data according to one or more embodiments. As shown in FIG. 7, each user can utilize one or more authentication IDs. As described above, the credential information may include an ID and a password. The MFP table includes a plurality of credential sets for each user, and each of the plurality of credential sets corresponds to each of the use-case information. If the received use-case information includes one or more servers among the cloud servers CLD1-CLD3 and the external application servers EAS1-EAS2, the processor 120 obtains the corresponding one or more credential sets of the servers (note: the “No entry” cell of the MFP table indicates that there is no access authority to the server). The processor 120 obtains, from the user data 110, the credential information corresponding to the authentication ID and to the use-case information. Advantageously, in one or more embodiments, because the credential information obtained by the authentication server 100 is limited to that relating to the specific function the user intends to use, the processor 120 does not transmit any unnecessary or extraneous credential information. By limiting the amount of sensitive credential information being transmitted, the authentication server 100 can establish higher security and suppress communication load of the authentication system 1. Further, because the credential information is transmitted only to the server device that requires that credential information, security of the authentication system 1 is further enhanced.

The credential information allows the MFP client 205 to access an external server, e.g., the external application servers EAS1-EAS2 or the cloud servers CLD1-CLD3 and the management server 180. Because different tables exist for each device type, the credential information can be differentiated for each device type.

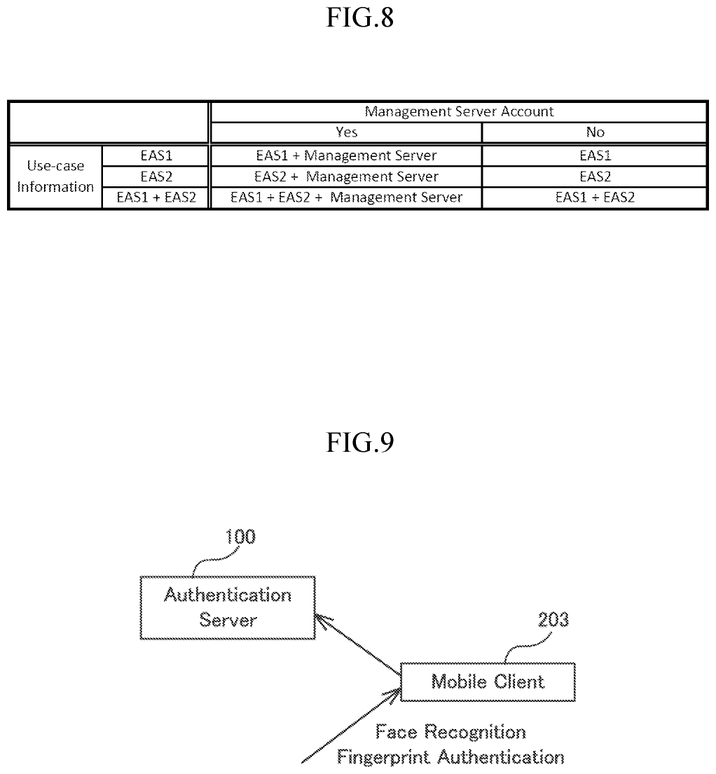

FIG. 8 shows a decision table for the MFP clients 204-205 for deciding the credential sets to be transmitted depending on the management server account, in accordance with one or more embodiments. As shown in FIG. 8, if the user of the MFP client has the management server account as access authority information, the credential information of the management server 180 is added to the other credential information corresponding to the use-case information. Specifically, for example, if the credential information of the external application server EAS2 is requested through the use-case information by a user who has the management server account, the processor 120 obtains the credential information of the management server 180 in addition to the credential information of the external application server EAS2. On the other hand, if the credential information of the external application server EAS2 is requested similarly by a user who does not have the management server account, the processor 120 obtains only the credential information of the external application server EAS2.

The management server 180 may store the credential information of the management server 180. If the management server 180 stores the management server account as an access authority information to access the management server 180, the processor 120 obtains the credential information of the management server 180 corresponding to the authentication ID from the management server 180. The management server 180 can also store individual information of users. The individual information may include an email address, a physical address, a telephone number, an account of communication service or an account of social networking service, etc. Since the client devices 201-205 can obtain the individual information, the client devices 201-205 can provide information to a user's favorable address or account.

Referring back to FIG. 6, at step S37, the processor confirms whether the credential information is obtained or not. Upon determining that no credential information exists, the processor 120 transmits the notification of “no credential information” to the MFP client 205 (step S39). When the processor 120 determines that the credential information exists, the processor 120 transmits the obtained credential information to the MFP client 205 (step S38). After transmitting to the MFP client 205, the processor 120 completes the process of the processor 120.

Referring back to FIG. 3, once the MFP client 205 receives the notification of “no credential information” (step S14), the authentication system process ends. Otherwise, the credential information is transmitted from the authentication server 100 to the MFP client 205 (step S15). Upon receiving the credential information, the MFP client 205 uses the credential information to access the external application server EAS2 to provide the function that the user requested (step S16).

For example, if the user requests to use “PullPrint” function, the MFP client 205 uses the received credential information for the external application server EAS2 to access the external application server EAS2. Once the credential information is authenticated by the external application server EAS2, the MFP client 205 downloads the appropriate document from the external application server EAS2, and prints the document out. In another example, if the user request to use “SendtoMe” function, the MFP client 205 uses the received credential information for the management server 180 to access the management server 180. Once the credential information is authenticated by the management server 180, the MFP client 205 obtains the user's email address. The MFP client 205 then scans the documents and sends them to the user's email address.

In step S22 of the flow F2 in FIG. 3, the mobile client 203 may directly authenticate the user by using biometric authentication such as face recognition or fingerprint authentication as shown in FIG. 9. If the authentication fails, the authentication system process ends. If the mobile client 203 successfully authenticates the user's input, the mobile client 203 obtains second use-case information and a second device type that indicates the machine type of the mobile client 203.

Similarly to the flow F1, the authentication ID, the second use-case information and the second device type constitute a second information as shown in FIG. 5. The second information is transmitted from the mobile client 203 to the authentication server 100 (step S23). If the authentication server 100 receives the second information, the process of the authentication server 100 is executed (step S30). The process of the authentication server 100 as shown in FIG. 6 may be the same as the flow F1, and therefore its description is omitted.

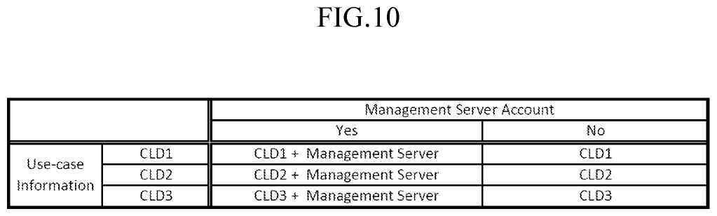

FIG. 10 shows a decision table for the mobile clients 202-203 or the computer client 201 for deciding the credential sets to be transmitted depending on the management server account. As shown in FIG. 10, similarly to the above explanation of FIG. 8, if the user of the mobile client 203 has the management server account as an access authority information, the credential information of the management server 180 is added to the other credential information corresponding to the second use-case information. For example, if the user has the management server account and the second use-case information requests the credential of the cloud server CLD2, the processor 120 obtains the credential information of the management server in addition to the credential information of the cloud server CLD2. On the other hand, if the user does not have the management server account and the second use-case information requests the credential information of the cloud server CLD2, the processor 120 obtains only the credential information of the cloud server CLD2.

Referring back to FIG. 3, if the mobile client 203 receives the notification of “no credential information” (step S24), the authentication system process ends. Otherwise, the second credential information is transmitted from the authentication server 100 to the mobile client 203 (step S25). Upon receiving the second credential information, the mobile client 203 uses the second credential information to access the cloud server CLD2 to provide the function that the user requested (step S26).

Advantageously, in one or more embodiments, because the credential information obtained by the authentication server is limited to that relating to the specific function the user is about to use, the processor 120 does not transmit any unnecessary or extraneous credential information. By limiting the amount of sensitive credential information being transmitted, the authentication server 100 can establish higher security and suppress communication load of the authentication system 1. Further, because the credential information is transmitted only to the server device that requires that credential information, security of the authentication system 1 is further enhanced. Moreover, the authentication server 100 stores the credential information for a plurality of the client devices, the authentication server 100 provides different credential information depending on the plurality of the client devices.

The computer client 201, the mobile clients 202 and the MFP client 204 can also operate similarly to that of the MFP client 205 or the mobile client 203 as described above, together with or without the authentication device 210. If the client devices 201-205 include the authentication device 210 or the function of the authentication device 210, the client devices 201-205 can authenticate the user input and transmit the authentication ID to the authentication server 100 without using the separated authentication device 210.

Although the disclosure has been described with respect to only a limited number of embodiments, those skilled in the art, having benefit of this disclosure, will appreciate that various other embodiments may be devised without departing from the scope. Accordingly, the scope of the invention should be limited only by the attached claims.

1. An authentication server comprising:
a data storage that stores user data and original authentication identification; and
a processor that:
receives:
first information including an authentication identification, a first device type, and first use-case information that identifies one or more external servers requested to be accessed from a first client device indicated by the first device type; and
second information including the authentication identification, a second device type, and second use-case information that identifies one or more of the external servers requested to be accessed from a second client device indicated by the second device type;
performs an authentication by comparing the authentication identification with the original authentication identification stored in the data storage;
obtains, from the user data upon successful authentication, first credential information corresponding to the first information and second credential information corresponding to the second information; and
transmits the first credential information to the first client device and the second credential information to the second client device.

2. The authentication server according to claim 1, wherein the credential information includes a plurality of credential sets, each composed of an ID and a password.

3. The authentication server according to claim 1, wherein the first credential information and the second credential information are stored in tables that are different for each device type.

4. The authentication server according to claim 1, wherein:
the first client device is a MFP (Multi-Function Peripheral) client; and
by using the first credential information to obtain a document to be printed out, the MFP client accesses the one or more of the external servers designated by the first use-case information.

5. The authentication server according to claim 1, wherein, when the user data stores an access authority information to a management server corresponding to the authentication identification, the first credential information and the second credential information both include credential information of the management server.

6. The authentication server according to claim 5, wherein the processor further obtains the credential information of the management sever from the management server.

7. The authentication server according to claim 5, wherein the management server stores individual information of a plurality of users.

8. The authentication server according to claim 7, wherein:
the first client device is a MFP (Multi-Function Peripheral) client;
the MFP client accesses the management server by using the credential information of the management server to obtain an email address as the individual information; and
the MFP client scans a document and send the scanned document to the email address.

9. An authentication system comprising:
a first client device that transmits first information including an authentication identification, a first device type corresponding to the first client device, and first use-case information that identifies one or more external servers requested to be accessed by the first client device;
a second client device that transmits second information including an authentication identification, a second device type corresponding to the second client device, and first use-case information that identifies one or more of the external servers requested to be accessed by the second client device;
an authentication server comprising a data storage that stores user data and original authentication identification, wherein the authentication server:
receives the first information and the second information;
performs an authentication by comparing the authentication identification with the original authentication identification stored in the data storage; and
upon successful authentication, transmits first credential information corresponding to the first information to the first client device and second credential information corresponding to the second information to the second client device; and
a communication network that connects the authentication server with the client device;
wherein the first client device uses the first credential information to access the one or more of the external servers designated by the first use-case information; and
the second client device uses the second credential information to access the one or more of the external servers designated by the second use-case information.

10. The authentication system according to claim 9, wherein the first credential information and the second credential information are stored in tables that are different for each device type.

11. The authentication system according to claim 9, wherein
the first client device is a MFP (Multi-Function Peripheral) client; and
by using the first credential information to obtain a document to be printed out, the MFP client accesses the one or more of the external servers designated by the first use-case information.

12. The authentication system according to claim 9, when the authentication server stores an access authority information to a management server corresponding to the authentication identification, the first credential information and the second credential information both include credential information of the management server.

13. The authentication system according to claim 12, wherein the authentication server further receives the credential information of the management server from the management server.

14. The authentication system according to claim 12, wherein the management server stores individual information of a plurality of users.

15. The authentication system according to claim 14, wherein
the first client device is a MFP (Multi-Function Peripheral) client;
the MFP client accesses the management server by using the credential information of the management server to obtain an email address as the individual information;
the MFP client scans a document and send the scanned document to the email address.

16. A method for an authentication comprising:
storing user data and original authentication identification;
receiving:
first information including an authentication identification, a first device type, and first use-case information that identifies one or more external servers requested to be accessed from a first client device indicated by the first device type; and
second information including the authentication identification, a second device type and second use-case information that identifies one or more of the external servers requested to be accessed from a second client device indicated by the second device type;
performing an authentication by comparing the authentication identification with the original authentication identification stored in the data storage;
obtaining from the user data upon successful authentication first credential information corresponding to the first information and second credential information corresponding to the second; and
transmitting the first credential information to the first client device and the second credential information to the second client device.
